(19) United States
(12) Patent Application Publication
(10) Pub. No.: US 2025/0357774 A1
(43) Pub. Date: Nov. 20, 2025

(54) CHARGING CONTROL METHOD, ENERGY STORAGE DEVICE AND READABLE STORAGE MEDIUM

(71) Applicant: SHARGE Technology (Shenzhen) Co., Ltd., Shenzhen (CN)

(72) Inventors: Wancheng Zhou, Shenzhen (CN); Bo Zhang, Shenzhen (CN); Pan Chen, Shenzhen (CN); Taohui Zheng, Shenzhen (CN)

(21) Appl. No.: 18/897,458

(22) Filed: Sep. 26, 2024

(30) Foreign Application Priority Data
May 20, 2024 (CN) 2024106205742

(51) Int. Cl. H02J 7/00

(52) U.S. Cl. CPC H02J 7/0071; H02J 7/00036; H02J 7/00714; H02J 7/007182; H02J 2207/20

(57) ABSTRACT

This application provides a charging control method, an energy storage device and a computer-readable storage medium, the method includes: if the power supply device supports the programmable power supply, disconnecting the connection between the DC-to-DC conversion unit and the battery module, controlling the power supply device to supply power to the charge pump unit with the programmable power supply and controlling the charge pump unit to charge the battery module; if the power supply device supports multiple power data objects to supply power, disconnecting the connection between the charge pump unit and the battery module, controlling the power supply device to supply power to the DC-to-DC conversion unit based on a power supply mode with a fixed power data object, and controlling the DC-to-DC conversion unit to charge the battery module.

### CROSS-REFERENCE TO RELATED APPLICATIONS

The present disclosure claims priority of the Chinese Patent application No. 2024106205742 entitled “CHARGING CONTROL METHOD, ENERGY STORAGE DEVICE AND READABLE STORAGE MEDIUM” filed on May 20, 2024, to the China National Intellectual Property Administration, the entire contents of which are incorporated herein by reference.

### TECHNICAL FIELD

The present disclosure relates to the field of power sources technology, and in particularly to a charging control method, an energy storage device and a computer-readable storage medium.

### BACKGROUND

At present, with the development of fast charging technology, the semiconductor industry and battery technology, various energy storage devices (for example, mobile phones and mobile power banks) have launched fast charging technologies one after another. Different power requirements and different battery modules have given rise to a wide variety of DC-to-DC (Direct Current to Direct Current) conversion units. The DC-to-DC conversion unit usually converts the fixed voltage output by the power supply device within a certain voltage range into the voltage required for charging the battery module. During the charging process, the greater the charging power, the greater the energy loss of the DC-to-DC conversion unit, resulting in more heat generated by the DC-to-DC conversion unit. That not only reduces the charging efficiency of the battery module but also poses safety hazards.

Therefore, how to ensure that the battery module is charged with high power while taking into account the charging efficiency and safety of the battery module has become an urgent problem to be solved.

### SUMMARY OF THE INVENTION

This application provides a charging control method, an energy storage device and a computer-readable storage medium, which can solve the problem in the related technology that the charging efficiency and safety of the battery module are affected when the battery module is charging with the high power.

In the first aspect, this application provides a charging control method, which is applied to a power controller in an energy storage device, the energy storage device further includes a charging and discharging interface, a DC-to-DC conversion unit, a charge pump unit, and a battery module, the DC-to-DC conversion unit is connected between the charging and discharging interface and the battery module, the charge pump unit is connected between the charging and discharging interface and the battery module; the method includes: when detecting that the power supply device is connected to the charging and discharging interface, obtaining a power supply capability information of the power supply device, the power supply capability information includes that the power supply device can support multiple power data objects to supply power or support a programmable power supply; if the power supply device supports the programmable power supply, disconnecting the connection between the DC-to-DC conversion unit and the battery module, controlling the power supply device to supply power to the charge pump unit with the programmable power supply, and controlling the charge pump unit to charge the battery module; if the power supply device supports multiple power data objects to supply power, disconnecting the connection between the charge pump unit and the battery module, controlling the power supply device to supply power to the DC-to-DC conversion unit based on a power supply mode with a fixed power data object, and controlling the DC-to-DC conversion unit to charge the battery module.

The above charging control method, through supporting a mode with the programmable power supply in the power supply device, controlling the power supply device to supply power to the charge pump unit according to the mode with the programmable power supply, and controlling the charge pump unit to charge the battery module, it can perform a high-power fast charging with low voltage and large current by using the charge pump unit to charge the battery module when the battery module has a high-rate charging characteristic and the power supply device supports the programmable power supply, this can significantly reduce charging time, prevent the battery module from working in a high-temperature environment for extended periods, and ensure the charging efficiency and safety of the battery module. Through supporting a power supply mode with multiple power data objects in the power supply device, controlling the power supply device to supply power to the DC-to-DC conversion unit according to the power supply mode with multiple power data objects, it can control the power supply device to supply power to the DC-to-DC conversion unit by using a power supply mode with the fixed power data object when the power supply device does not support the programmable power supply, which can improve the compatibility of the energy storage device.

In the second aspect, this application further provides an energy storage device, the energy storage device includes a memory and a processor; the memory is configured to store a computer program; the processor is configured to execute the computer program and implement the above charging control method.

In the third aspect, this application further provides a computer-readable storage medium, the computer-readable storage medium stores a computer program, when the computer program is executed by a processor, the processor implements the above charging control method.

### BRIEF DESCRIPTION OF THE DRAWINGS

In order to clearly illustrate the technical solutions in the embodiments of the present application, the following will briefly introduce the drawings used in the description of the embodiments. Apparently, the drawings in the following description are some embodiments of the present application. For those of ordinary skill in the art, without making any creative efforts, other drawings can be obtained based on these drawings.

FIG. 1 is a structural block diagram of an energy storage device provided in an embodiment of this application.

FIG. 2 is a structural block diagram of a second type of energy storage device provided in an embodiment of this application.

FIG. 3 is a structural block diagram of a third type of energy storage device provided in an embodiment of this application.

FIG. 4 is a simplified circuit diagram of a first voltage conversion circuit provided in an embodiment of this application.

FIG. 5 is a schematic structural diagram of an energy storage device provided in an embodiment of this application.

FIG. 6 is a schematic flowchart of a charging control method provided in an embodiment of this application.

FIG. 7 is a schematic flowchart of a sub-step for a programmable power supply provided in an embodiment of this application.

FIG. 8 is a schematic flowchart of a sub-step for dynamically adjusting the output of a power supply device provided in an embodiment of this application.

FIG. 9 is a charging curve diagram of a lithium battery in traditional technology.

FIG. 10 is a charging curve diagram of a battery module supplied power with a programmable power supply based on the fast charging protocol of the USB Type-C interface provided in an embodiment of this application.

FIG. 11 is a schematic flowchart of a sub-step for controlling the power supply device to supply power to a DC-to-DC conversion unit provided in an embodiment of this application.

FIG. 12 is a relationship curve diagram between the conversion efficiency and different voltage differences in a DC-to-DC conversion unit provided in an embodiment of this application.

### DETAILED DESCRIPTION

The technical solution of embodiments of the present disclosure is clearly and completely described in detail in connection with the accompanying drawings. Described embodiments are some embodiments of the present disclosure, not all embodiments. Based on embodiments of the present disclosure, all other embodiments obtained by those of ordinary skill in the art without creative efforts are within the scope of the present disclosure.

In the relevant technologies, due to the conversion efficiency issue of the DC-to-DC conversion unit, the greater the charging power of the DC-to-DC conversion unit during the charging process, the greater the energy loss of the DC-to-DC conversion unit, resulting in more heat generated by the DC-to-DC conversion unit. This makes the battery module work in a high-temperature environment for extended periods, which not only reduces the charging efficiency of the battery module but also poses safety hazards.

To this end, the embodiments of this application provide a charging control method, an energy storage device and a computer-readable storage medium. Through supporting the programmable power supply in the power supply device, controlling the power supply device to supply power to the charge pump unit according to the mode with the programmable power supply, and controlling the charge pump unit to charge the battery module, it can perform a high-power fast charging with low voltage and large current by using the charge pump unit to charge the battery module when the battery module has a high-rate charging characteristic and the power supply device supports the programmable power supply, this can significantly reduce charging time, prevent the battery module from working in a high-temperature environment for extended periods, and ensure the charging efficiency and safety of the battery module. The following will provide a detailed explanation of how to control an external power supply device to charge the energy storage device.

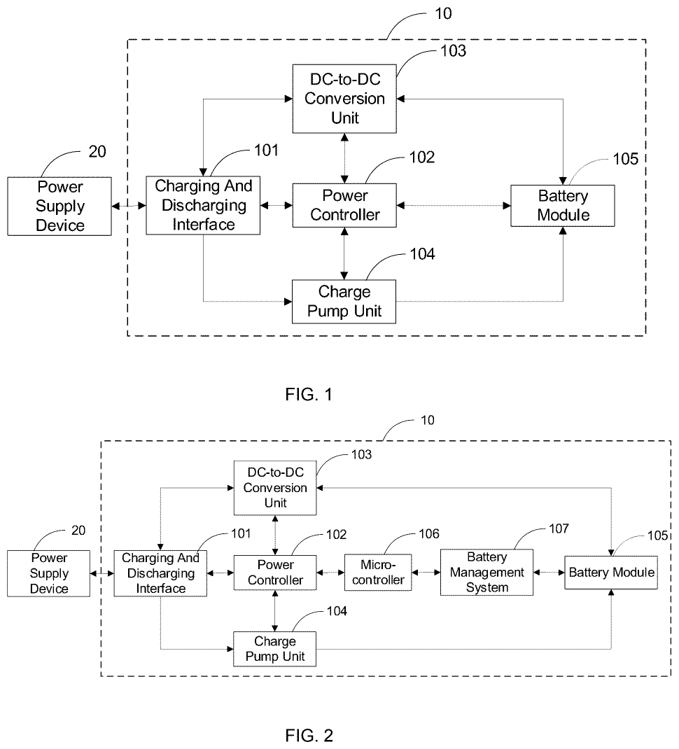

Please refer to FIG. 1, FIG. 1 is a structural block diagram of an energy storage device 10 provided in an embodiment of this application. The energy storage device 10 includes a charging and discharging interface 101, a power controller 102, a DC-to-DC conversion unit 103, a charge pump unit 104 and a battery module 105.

As shown in FIG. 1, the DC-to-DC conversion unit 103 is connected between the charging and discharging interface 101 and the battery module 105. The charge pump unit 104 is connected between the charging and discharging interface 101 and the battery module 105. The power controller 102 is respectively connected to the charging and discharging interface 101, the DC-to-DC conversion unit 103, the charge pump unit 104 and the battery module 105. For example, the power controller 102 can be respectively connected to the charging and discharging interface 101, the DC-to-DC conversion unit 103, the charge pump unit 104 and the battery module 105 through a bus. The bus can be any applicable bus such as an inter-integrated circuit (I2C) bus.

For example, the energy storage device 10 can include but is not limited to mobile power banks, portable direct current (DC) energy storage devices, electronic devices, and so on. The electronic devices can include but are not limited to smart phones, tablet personal computers and laptops that support fast charging.

In the embodiment of this application, the energy storage device 10 can support a PD (Power Delivery) fast charging protocol (a fast charging protocol based on the USB Type-C interface), and can be charged by a power supply device 20 with fast charging function. For example, the energy storage device 10 can communicate and charge with the power supply device 20 with fast charging function based on the fast charging protocol of the USB Type-C interface. The power supply device 20 can include an external power adapter, external power sources can be connected to the energy storage device 10 through the power adapter. For example, external power sources can include photovoltaic charging power sources, alternating current power sources, etc.

It should be noted that, the power supply device 20 with fast charging function can support multiple power data objects (PDOs). Multiple power data objects refer to different voltages output by the power supply device 20. For example, PD3.0 and PD3.1 fast charging protocols support multiple power data objects such as 5V, 9V, 12V, 15V and 20V. Additionally, the power supply device 20 with fast charging function can or can not support a programmable power supply (PPS). The programmable power supply refers to the ability of the power supply device 20 to dynamically adjust its output voltage within a range of V_{PPS_min} to V_{PPS_max}, V_{PPS_min} refers to minimum output voltage output by the power supply device 20, V_{PPS_max} refers to maximum output voltage output by the power supply device 20. It is understandable that the programmable power supply is an optional function of both PD3.0 and PD3.1 fast charging protocols.

As shown in FIG. 1, the power supply device 20 can be connected to the charging and discharging interface 101, and charge the battery module 105 through the DC-to-DC conversion unit 103 or the charge pump unit 104. The charging and discharging interface 101 can be connected to the external power source through the power adapter, it can also be connected to the external power-consuming device (not shown in FIG. 1), which makes the energy storage device 10 charge the power-consuming device. At this time, the battery module 105 can charge the power-consuming device through the DC-to-DC conversion unit 103.

The power controller 102, which is a micro-controller with power delivery controller, is configured to interact with the external power supply device 20 or the power-consuming device through fast charging protocols, and charge itself according to the needs of the power supply device 20 or discharge according to the needs of the power-consuming device. The power controller 102 can control the DC-to-DC conversion unit 103 through a digital interface or an analog interface. The power controller 102 can communicate with the external power supply device 20 through a communication line of the charging and discharging interface 101 to obtain a power supply capability information of the power supply device 20. When the charging and discharging interface 101 is a USB Type-C interface, the communication line can include pins such as CC1, CC2, DP and DM. When the charging and discharging interface 101 is a USB Type-A interface, the communication line can include pins such as DP and DM.

The DC-to-DC conversion unit 103 is configured to convert the input of the power supply device 20 into the charging input required by the battery module 105, and convert the output of the battery module 105 into the charging input required by the power-consuming device. In some embodiments, the DC-to-DC conversion unit 103 is configured to charge the battery module 105 based on the output power of the power supply device 20 when it supports multiple power data objects to supply power.

In an embodiment of this application, the DC-to-DC conversion unit 103 and the power controller 102 can be configured to integrate into a system-on-a-chip (SoC). It should be noted that, by integrating the DC-to-DC conversion unit 103 and the power controller 102 into a system on a chip, the design flexibility can be enhanced to meet various usage scenarios.

The charge pump unit 104 is configured to convert the input of the external power supply device 20 into the charging input required by the battery module 105. In some embodiments, the charge pump unit 104 is configured to charge the battery module 105 based on the output power of the power supply device 20 when it supports the programmable power supply. The charge pump unit 104 can include a charge pump, the charge pump is configured to fast charge the battery module 105 with large current.

Please refer to FIG. 2, FIG. 2 is a structural block diagram of a second type of energy storage device provided in an embodiment of this application. As shown in FIG. 2, the energy storage device 10 can include a charging and discharging interface 101, a power controller 102, a DC-to-DC conversion unit 103, a charge pump unit 104, a battery module 105, a micro-controller 106 and a battery management system 107.

As shown in FIG. 2, the DC-to-DC conversion unit 103 is connected between the charging and discharging interface 101 and the battery module 105. The charge pump unit 104 is connected between the charging and discharging interface 101 and the battery module 105. The power controller 102 is connected respectively to the charging and discharging interface 101, the DC-to-DC conversion unit 103, the charge pump unit 104 and the micro-controller 106. The micro-controller 106 is connected to the battery management system 107. The battery management system 107 is connected to the battery module 105. For example, the power controller 102 is connected to the charging and discharging interface 101, the DC-to-DC conversion unit 103, the charge pump unit 104 and the micro-controller 106 through a bus, the bus can be any applicable bus such as an inter-integrated circuit (I2C) bus.

The micro-controller 106 is an independent controller responsible for human-computer interaction and assisting in monitoring the state of the entire system. For example, the micro-controller 106 can communicate with the battery management system 107 to obtain the battery state and charging state of the battery module 105, or to set parameters for the battery module 105, for example, setting the charging voltage, the discharging voltage, the charging current, the discharging current. The micro-controller 106 can also communicate with the power controller 102, for example, to obtain a power supply capability information of the power supply device 20 reported by the power controller 102, and to instruct the power controller 102 to control the power supply device 20 to output power to the DC-to-DC conversion unit 103, which makes the DC-to-DC conversion unit 103 charge the battery module 105 according to the output power of the power supply device 20.

The battery management system (BMS) 107 is configured to manage various aspects of the battery module 105, including charging and discharging management, balancing of series-connected cells, overcharge protection, over-discharge protection, and over-temperature protection. For example, it can collect a charging requirement information of the battery module 105 and report the charging requirement information to the micro-controller 106.

In some embodiments, the micro-controller 106 can be integrated within the system-on-a-chip, or it can be set up external to the system-on-a-chip.

In some embodiments, the battery management system 107 can be integrated within the system-on-a-chip, or it can be set up external to the system-on-a-chip.

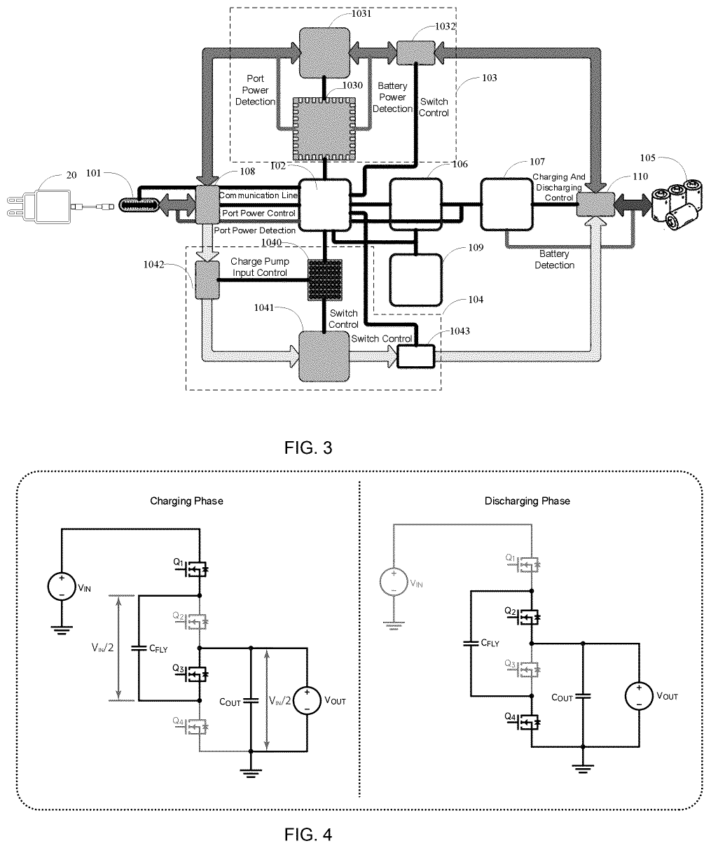

Please refer to FIG. 3, FIG. 3 is a structural block diagram of a third type of energy storage device provided in an embodiment of this application. As shown in FIG. 3, the energy storage device 10 can also include a first switching circuit 108. The first switching circuit 108 is connected to the charging and discharging interface 101, the charge pump unit 104, the DC-to-DC conversion unit 103 and the power controller 102; the first switching circuit 108 is controlled by the power controller 102, and it is a bidirectional power path switch between the charging and discharging interface 101 and the DC-to-DC conversion unit 103.

For example, the first switching circuit 108 is configured to conduct the connection between the charging and discharging interface 101 and a second switching circuit 1042 when receiving a first conduction signal of the power controller 102. When the power supply device 20 charges the battery module 105 through the charge pump unit 104, the power controller 102 can control the first switching circuit 108 to be conducted.

The first switching circuit 108 can include but is not limited to a bipolar junction transistor, a metal-oxide-semiconductor field-effect transistor or an insulated gate bipolar transistor, etc.

As shown in FIG. 3, the charge pump unit 104 can also include a charge pump controller 1040, a first voltage conversion circuit 1041, a second switching circuit 1042 and a third switching circuit 1043. One end of the first switching circuit 108 is connected to the charging and discharging interface 101, the other end of the first switching circuit 108 is connected to a first end of the second switching circuit 1042, a second end of the second switching circuit 1042 is connected to the first voltage conversion circuit 1041, a third end of the second switching circuit 1042 is connected to the charge pump controller 1040, a first end of the third switching circuit 1043 is connected to the first voltage conversion circuit 1041, a second end of the third switching circuit 1043 is connected to the battery module 105, and a third end of the third switching circuit 1043 is connected to the power controller 102. The charge pump controller 1040 is also connected to the power controller 102.

The charge pump controller 1040 is configured to control the first voltage conversion circuit 1041 to convert the input of the power supply device 20 into the charging input required by the battery module 105. The second switching circuit 1042 is configured to conduct the connection between the first switching circuit 108 and the first voltage conversion circuit 1041 when receiving a second conduction signal of the charge pump controller 1040, that makes the first voltage conversion circuit 1041 convert voltages based on the input of the power supply device 20. The third switching circuit 1043 is configured to conduct the connection between the first voltage conversion circuit 1041 and the battery module 105 when receiving a third conduction signal from the power controller 102, that makes the first voltage conversion circuit 1041 charge the battery module 105.

For example, the switching transistors in the second switching circuit 1042 and the third switching circuit 1043 can include but are not limited to bipolar junction transistors, metal-oxide-semiconductor field-effect transistors or insulated gate bipolar transistors, etc. The embodiments of this application do not limit the types of the switching transistors in the second switching circuit 1042 and the third switching circuit 1043.

As shown FIG. 3, the DC-to-DC conversion unit 103 can include a DC-to-DC converter 1030, a second voltage conversion circuit 1031 and a fourth switching circuit 1032, a first end of the second voltage conversion circuit 1031 is connected to the first switching circuit 108, a second end of the second voltage conversion circuit 1031 is connected to a first end of the fourth switching circuit 1032, a second end of the fourth switching circuit 1032 is connected to the battery module 105, a third end of the fourth switching circuit 1032 is connected to the power controller 102; the DC-to-DC converter 1030 is connected to a third end of the second voltage conversion circuit 1031.

For example, the second voltage conversion circuit 1031 can be a bidirectional buck-boost circuit composed of four switching transistors and an inductor, for example, a H-Bridge circuit. Of course, the second voltage conversion circuit 1031 can also be other types of voltage conversion circuits, there are no specific limitations here. The switching transistor in the second voltage conversion circuit 1031 can include but is not limited to a bipolar junction transistor, a metal-oxide-semiconductor field-effect transistor or an insulated gate bipolar transistor, etc.

The fourth switching circuit 1032 is configured to conduct the connection between the second voltage conversion circuit 1031 and the battery module 105 when receiving a fourth conduction signal of the power controller 102.

For example, the switching transistor in the fourth switching circuit 1032 can include but is not limited to a bipolar junction transistor, a metal-oxide-semiconductor field-effect transistor or an insulated gate bipolar transistor, etc.

It should be noted that, when the power supply device 20 charges the battery module 105 through the DC-to-DC conversion unit 103, the power controller 102 can control the fourth switching circuit 1032 to conduct the connection between the second voltage conversion circuit 1031 and the battery module 105, which makes the second voltage conversion circuit 1031 convert the voltages based on the input of the power supply device 20, and charge the battery module 105.

As shown in FIG. 3, the energy storage device 10 further includes an interactive module 109 and a fifth switching circuit 110. The fifth switching circuit 110 is a charging and discharging path switch and is controlled by the battery management system 107. When the battery module 105 is in a normal battery state, the fifth switching circuit 110 is in a normally open state. The interactive module 109 can be an input module (such as an button, an switch, etc.), and can also be an output module (such as an LED light, a display module), or other types of interactive modules. The switching transistor in the fifth switching circuit 110 can include but is not limited to a bipolar junction transistor, a metal-oxide-semiconductor field-effect transistor or an insulated gate bipolar transistor, etc.

In some embodiments, during the charging phase, the output voltage of the first voltage conversion circuit 1041 is half of the input voltage. During the discharging phase, the output current of the first voltage conversion circuit 1041 is twice the input current.

In an embodiment of this application, the first voltage conversion circuit 1041 is a DC-to-DC converter 1030 based on switch-capacitor technology (also known as a charge pump), which uses capacitors as energy storage elements for voltage conversion. It can halve the voltage and at the same time double the current, thus enabling high-efficiency, high-current fast charging.

It should be noted that, when the battery module 105 has a smaller number of cells in series, the battery voltage of the battery module 105 is relatively low. Therefore, by configuring the first voltage conversion circuit 1041 to halve the input voltage, it can meet the charging voltage requirements of the battery module 105. For example, a lithium cell requires a charging voltage of 4.2V, two cells connected in series would require a charging voltage of 8.4V. Thus, the input end of the first voltage conversion circuit 1041 need provide a voltage of at least 16.8V, which is just close to the 20V level provided by PD fast charging. Moreover, the programmable power supply feature of PD fast charging supports voltage adjustment.

In the aforementioned embodiment, due to the fact that the battery module 105 has the highest charging efficiency when charging at a low voltage and a high current, using the first voltage conversion circuit 1041 to halve the voltage while doubling the current can not only ensure that the battery module 105 is charged with the highest charging efficiency but also prevent the charging voltage of the battery module 105 from being too high. This can extend the lifespan of the battery module 105 and enhance its safety.

Please refer to FIG. 4, FIG. 4 is a simplified circuit diagram of a first voltage conversion circuit provided in an embodiment of this application. As shown in FIG. 4, the first voltage conversion circuit 1041 includes a first energy storage capacitor C_{FLY}, a second energy storage capacitor C_{OUT}, a first switching transistor Q1, a second switching transistor Q2, a third switching transistor Q3 and a fourth switching transistor Q4. A first end of the first switching transistor Q1 is connected to a power source end V_{IN}, a second end of the first switching transistor Q1 is connected to a first end of the second switching transistor Q2, a second end of the second switching transistor Q2 is connected to a first end of the third switching transistor Q3, a second end of the third switching transistor Q3 is connected to a first end of the fourth switching transistor Q4, the fourth switching transistor Q4 is grounded. A first end of the first energy storage capacitor C_{FLY} is connected to the common node between the second end of the first switching transistor Q1 and the first end of the second switching transistor Q2, a second end of the first energy storage capacitor C_{FLY} is connected to the common node between the second end of the third switching transistor Q3 and the first end of the fourth switching transistor Q4, a first end of the second energy storage capacitor C_{OUT} is connected to the common node between the second end of the second switching transistor Q2 and the first end of the third switching transistor Q3, a second end of the second energy storage capacitor C_{OUT} is connected to the second end of the fourth switching transistor Q4.

As shown in FIG. 4, during the charging phase, the first switching transistor Q1 and the third switching transistor Q3 are configured to be conducted, the second switching transistor Q2 and the fourth switching transistor Q4 are configured to be off, and the first energy storage capacitor C_{FLY} is connected in series with the second energy storage capacitor C_{OUT}. During the discharging phase, the first switching transistor Q1 and the third switching transistor Q3 are configured to be off, the second switching transistor Q2 and the fourth switching transistor Q4 are configured to be conducted, the first energy storage capacitor C_{FLY} is connected in parallel with the second energy storage capacitor C_{OUT}.

It should be noted that, when the first energy storage capacitor C_{FLY} is connected in series with the second energy storage capacitor C_{OUT}, the voltage across both terminals of the first energy storage capacitor C_{FLY} and the second energy storage capacitor C_{OUT} is V_{IN}/2 each, that is the output voltage V_{OUT}=V_{IN}/2, V_{IN} refers to the voltage of the power source end, which can be understood as the voltage input by the power supply device 20. When the first energy storage capacitor C_{FLY} is connected in parallel with the second energy storage capacitor C_{OUT}, the first energy storage capacitor C_{FLY} and the second energy storage capacitor C_{OUT}, after being fully charged, discharge to the external circuit. The parallel configuration results in the output current being twice the input current of the charging phase.

It should be noted that, during the charging phase, by configuring the first switching transistor Q1 and the third switching transistor Q3 to be conducted and configuring the second switching transistor Q2 and the fourth switching transistor Q4 to be off, the first energy storage capacitor C_{FLY} and the second energy storage capacitor C_{OUT} can be connected in series, thereby enabling the output voltage of the first voltage conversion circuit 1041 to be half of the input voltage. During the discharging phase, by configuring the first switching transistor Q1 and the third switching transistor Q3 to be off and configuring the second switching transistor Q2 and the fourth switching transistor Q4 to be conducted, the first energy storage capacitor C_{FLY} and the second energy storage capacitor C_{OUT} can be connected in parallel, thereby enabling the output current of the first voltage conversion circuit 1041 to be twice the input current of the charging phase.

In the aforementioned embodiment, by using the charge pump to charge the battery module 105, since the charge pump has high conversion efficiency and low heat loss during fast charging, the battery module can be charged in an extremely short time, greatly enhancing the user experience. Additionally, it can also prevent the battery module from working in a high-temperature environment for a long time, ensuring the charging efficiency and safety of the battery module.

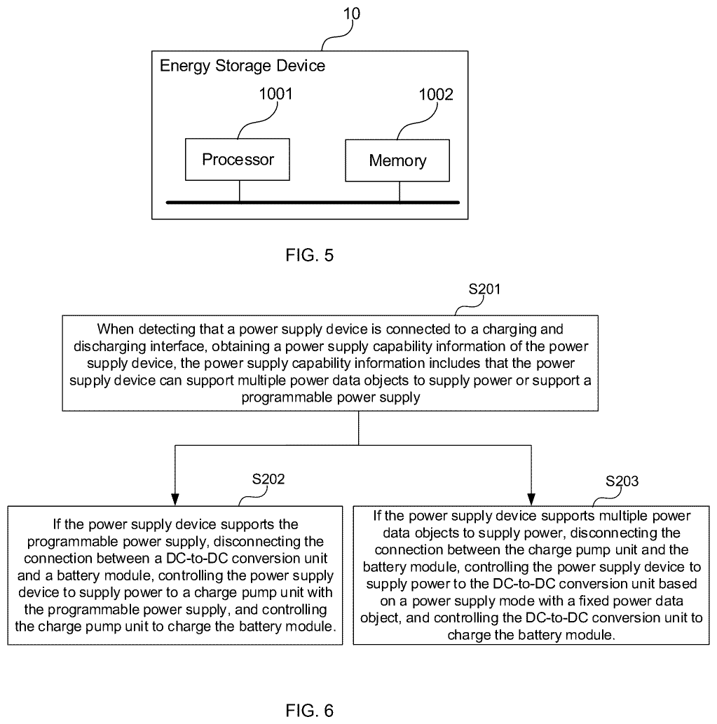

Please refer to FIG. 5, FIG. 5 is a schematic structural diagram of an energy storage device provided in an embodiment of this application. In FIG. 5, the energy storage device 10 includes a processor 1001 and a memory 1002, the processor 1001 and the memory 1002 are connected through a bus. The bus, for example, is an inter-integrated circuit (I2C) bus, a distributed soft bus.

The memory 1002 can include storage medium and an internal memory. The storage medium can store an operating system and a computer program. The computer program includes program instructions. When these program instructions are executed, the processor 1001 performs any one of charging control methods.

The processor 1001 is configured to provide computing and controlling, supporting the operation of the entire energy storage device 10. For example, the processor 1001 can be the power controller 102 in the aforementioned FIGS. 1 to 3, or the micro-controller 106 in the aforementioned FIGS. 2 to 3. It should be understood that, when the micro-controller 106 serves as an executing entity of the charging control method in the embodiments of this application, the micro-controller 106 can control the DC-to-DC conversion unit 103 and the charge pump unit 104 to work through the power controller 102.

The processor 1001 can be a central processing unit (CPU), and can also be a general-purpose processor, a digital signal processor (DSP), an application specific integrated circuit (ASIC), a field-programmable gate array (FPGA) or a programmable logic device, a discrete gate or transistor logic device, and a discrete hardware component, etc. The general-purpose processor can be a micro-processor or any conventional processor.

The processor 1001 is configured to invoke the computer program stored in the memory 1002 to perform the following steps.

When detecting that the power supply device is connected to the charging and discharging interface, obtaining a power supply capability information of the power supply device, the power supply capability information includes that the power supply device can support multiple power data objects to supply power or support a programmable power supply; if the power supply device supports the programmable power supply, disconnecting the connection between the DC-to-DC conversion unit and the battery module, controlling the power supply device to supply power to the charge pump unit with the programmable power supply, and controlling the charge pump unit to charge the battery module; if the power supply device supports multiple power data objects to supply power, disconnecting the connection between the charge pump unit and the battery module, controlling the power supply device to supply power to the DC-to-DC conversion unit based on a power supply mode with a fixed power data object, and controlling the DC-to-DC conversion unit to charge the battery module.

In some embodiments, when the processor 1001 realizes controlling the power supply device to supply power to a charge pump unit with the programmable power supply, the processor 1001 specifically performs the following steps.

Obtaining a charging requirement information of the battery module; according to the charging requirement information, configuring the programmable power supply for the power supply device to obtain programmable power supply parameters corresponding to the power supply device; controlling the power supply device to supply power to the charge pump unit according to the programmable power supply parameters.

In some embodiments, the charging requirement information includes a charging requirement voltage and a charging requirement current; when the processor 1001 realizes according to the charging requirement information, configuring the programmable power supply for the power supply device to obtain programmable power supply parameters corresponding to the power supply device, the processor 1001 specifically performs the following steps.

According to the charging requirement voltage, determining a power supply output voltage corresponding to the power supply device, the power supply output voltage is the sum of twice the charging requirement voltage and a preset voltage compensation value; according to the charging requirement current, determining a power supply output current corresponding to the power supply device, the power supply output current is the sum of half of the charging requirement current and a preset current compensation value; generating the programmable power supply parameters according to the power supply output voltage and the power supply output current.

In some embodiments, the energy storage device further includes a first switching circuit, the first switching circuit is connected to the charging and discharging interface and the charge pump unit; the programmable power supply parameters include a power supply output voltage and a power supply output current; when the processor 1001 realizes controlling the power supply device to supply power to the charge pump unit according to the programmable power supply parameters, the processor 1001 specifically performs the following steps.

Transmitting a first programmable power supply request to the power supply device, the first programmable power supply request is configured to indicate the power supply device to supply power to the charge pump unit according to the power supply output voltage and the power supply output current; after detecting an output voltage from the power supply device, controlling the first switching circuit to be conducted, and enabling the power supply device to supply power to the charge pump unit.

In some embodiments, the charge pump unit includes a charge pump controller and a first voltage conversion circuit, the charge pump controller is connected to the first voltage conversion circuit, one end of the first voltage conversion circuit is connected to the charging and discharging interface, other end of the first voltage conversion circuit is connected to the battery module; when the processor 1001 realizes controlling the charge pump unit to charge the battery module, the processor 1001 specifically performs the following steps.

Controlling the charge pump controller to enter a charging mode, to make the charge pump controller control the first voltage conversion circuit to charge the battery module after entering the charging mode.

In some embodiments, the processor 1001 further performs the following steps.

During controlling the charge pump unit to charge the battery module, obtaining a current charging voltage and a current charging current of the battery module, and obtaining a current port voltage and a current port current of the charging and discharging interface; according to the current charging voltage and the current port voltage, determining a voltage compensation variation value of the energy storage device, and according to the voltage compensation variation value, adjusting the power supply output voltage of the power supply device to obtain an adjusted power supply output voltage; according to the current charging current and the current port current, determining a current compensation variation value of the energy storage device, and according to the current compensation variation value, adjusting the power supply output current of the power supply device to obtain an adjusted power supply output current; transmitting a second programmable power supply request to the power supply device, the second programmable power supply request is configured to indicate the power supply device to supply power to the charge pump unit according to the adjusted power supply output voltage and/or the adjusted power supply output current.

In some embodiments, when the processor 1001 realizes controlling the power supply device to supply power to the DC-to-DC conversion unit based on a power supply mode with a fixed power data object, the processor 1001 specifically performs the following steps.

Obtaining a charging requirement information of the battery module; according to the charging requirement information and output voltages corresponding to multiple power data objects, determining a target output voltage corresponding to the power supply device, the target output voltage is an output voltage corresponding to one of multiple power data objects when a voltage difference between an input voltage and an output voltage of the DC-to-DC conversion unit is minimized; according to the target output voltage, controlling the power supply device to supply power to the DC-to-DC conversion unit.

In some embodiments, the charging requirement information includes a charging requirement voltage and a charging requirement current; when the processor 1001 realizes according to the charging requirement information and output voltages corresponding to multiple power data objects, determining a target output voltage, the processor 1001 specifically performs the following steps.

Obtaining a minimum voltage difference corresponding to the charging requirement current and a preset voltage compensation value; configuring the charging requirement voltage, minimum voltage difference and the voltage compensation value to obtain a target output voltage based on a preset minimum voltage difference formula and output voltages corresponding to multiple power data objects.

In some embodiments, the DC-to-DC conversion unit includes a DC-to-DC converter, a second voltage conversion circuit and a fourth switching circuit, the energy storage device further includes a first switching circuit, a first end of the second voltage conversion circuit is connected to the first switching circuit, a second end of the second voltage conversion circuit is connected to a first end of the fourth switching circuit, a second end of the fourth switching circuit is connected to the battery module, a third end of the fourth switching circuit is connected to the power controller; the DC-to-DC converter is connected to a third end of the second voltage conversion circuit; when the processor 1001 realizes controlling the DC-to-DC conversion unit to charge the battery module, the processor 1001 specifically performs the following steps.

Transmitting a fourth conduction signal to the fourth switching circuit to enable the fourth switching circuit to conduct the connection between the second voltage conversion circuit and the battery module after receiving the fourth conduction signal; according to the charging requirement information, configuring charging output parameters of the DC-to-DC converter, and setting a working mode of the DC-to-DC converter to a charging mode, to enable the DC-to-DC converter to control the second voltage conversion circuit to charge the battery module based on configured charging output parameters.

The following will combine the drawings to provide detailed descriptions of some embodiments of this application. In the case of no conflict, the embodiments and features of the embodiments described below can be combined with each other. Please refer to FIG. 6, FIG. 6 is a schematic flowchart of a charging control method provided in an embodiment of this application. As shown in FIG. 6, the charging control method includes the following steps.

In step 201, when detecting that a power supply device is connected to a charging and discharging interface, obtaining a power supply capability information of the power supply device, the power supply capability information includes that the power supply device can support multiple power data objects to supply power or support a programmable power supply.

It should be noted that, the charging control method provided by this application can be applied to a power controller within the energy storage device, as well as to a micro-controller within the energy storage device. To facilitate illustration, the following explanation will be based on the power controller as the executing entity.

For example, refer to FIG. 1 to FIG. 3, when detecting that the power supply device 20 is connected to the charging and discharging interface 101, the power controller 102 communicates with the power supply device 20 through the charging and discharging interface 101, and transmits a power supply capability request message to the power supply device 20. The power supply device 20 returns the power supply capability information of the power supply device 20 based on the power supply capability request message. For example, when the charging and discharging interface 101 is a USB Type-C interface, the power controller 102 communicates with the power supply device 20 based on the fast charging protocol of the USB Type-C interface, thereby obtaining the power supply capability information of the power supply device 20. Wherein the power supply capability information of the power supply device 20 includes that the power supply device 20 can support multiple power data objects to supply power or support a programmable power supply.

For example, when the power supply device 20 supports multiple power data objects to supply power, controlling the power supply device 20 to supply power to the DC-to-DC conversion unit 103 based on a power supply mode with the fixed power data object. It should be noted that, a power supply mode with the fixed power data object refers to controlling the power supply device 20 to supply power at a fixed power data object during the charging phase of the battery module 105. Wherein different charging phases correspond to different power data objects.

For example, when the power supply device 20 supports the programmable power supply, controlling the power supply device 20 to supply power to the charge pump unit 104.

Through obtaining the power supply capability information of the power supply device 20, it can be determined whether the power supply device 20 supports multiple power data objects to supply power or the programmable power supply based on the power supply capability information of the power supply device 20, subsequently, according to the power supply mode supported by the power supply device 20, the corresponding power supply strategy can be adopted to charge the battery module 105.

In step 202, if the power supply device supports the programmable power supply, disconnecting the connection between a DC-to-DC conversion unit and a battery module, controlling the power supply device to supply power to a charge pump unit with the programmable power supply, and controlling the charge pump unit to charge the battery module.

In some embodiments, when determining that the power supply device supports the programmable power supply, the power controller can disconnect the connection between the DC-to-DC conversion unit and the battery module, control the power supply device to supply power to the charge pump unit with the programmable power supply, and control the charge pump unit to charge the battery module.

For example, as shown in FIG. 3, when disconnecting the connection between the DC-to-DC conversion unit 103 and the battery module 105, transmitting a shutdown signal to the fourth switching circuit 1032, and controlling the fourth switching circuit 1032 to be turned off, which makes the fourth switching circuit 1032 disconnect the connection between the DC-to-DC conversion unit 103 and the battery module 105.

It should be noted that, by disconnecting the connection between the DC-to-DC conversion unit 103 and the battery module 105, it is realized that the power supply device 20 supplies power to the charge pump unit 104 with the programmable power supply, and it avoids the DC-to-DC conversion unit 103 from charging the battery module 105.

In the aforementioned embodiments, when the power supply device supports the programmable power supply, controlling the power supply device to supply power to the charge pump unit with the programmable power supply and controlling the charge pump unit to charge the battery module can perform a high-power fast charging with low voltage and large current by using the charge pump unit to charge the battery module when the battery module has a high-rate charging characteristic and the power supply device supports the programmable power supply mode, this can significantly reduce charging time, prevent the battery module from working in a high-temperature environment for extended periods, and ensure the charging efficiency and safety of the battery module.

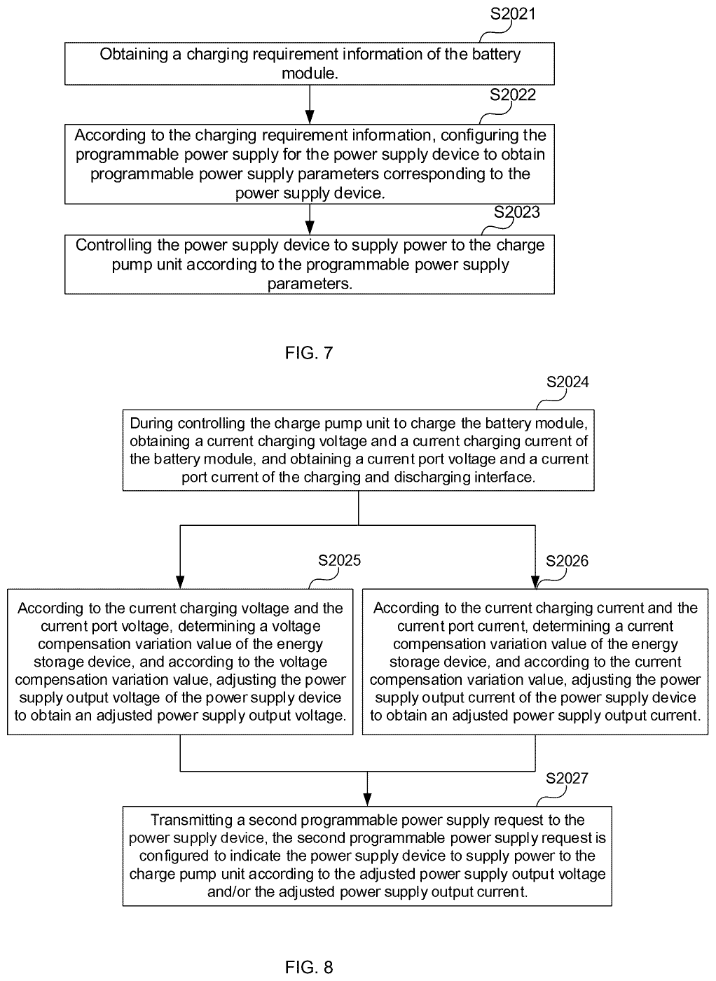

Please refer to FIG. 7, FIG. 7 is a schematic flowchart of a sub-step for a programmable power supply provided in an embodiment of this application. As shown in FIG. 7, in step 202, controlling the power supply device to supply power to a charge pump unit with the programmable power supply specifically includes the following steps.

In step 2021, obtaining a charging requirement information of the battery module.

For example, as shown in FIG. 3, the power controller 102 can obtain the charging requirement information of the battery module 105, wherein the charging requirement information is collected by the battery management system 107. For example, the power controller 102 requests the micro-controller 106 to obtain the charging requirement information of the battery module 105 collected by the battery management system 107. Wherein the charging requirement information includes a charging requirement voltage and a charging requirement current. The battery management system 107 can collect the charging requirement voltage and the charging requirement current of the battery module 105 in real time. The charging requirement voltage can be expressed as V_{BAT_chg}, and its voltage range is V_{BAT_TC}˜V_{BAT_TERM}. Wherein V_{BAT_TC} is a trickle charging voltage, V_{BAT_TERM} is a charging cutoff voltage at the end of charging. The charging requirement current can be expressed as I_{BAT_chg}, and its current range is 0˜I_{BAT_Chg_max}. Wherein I_{BAT_Chg_max} is a maximum charging current.

In step 2022, according to the charging requirement information, configuring the programmable power supply for the power supply device to obtain programmable power supply parameters corresponding to the power supply device.

In some embodiments, after obtaining the charging requirement information of the battery module, according to the charging requirement information, the power controller can configure the programmable power supply for the power supply device to obtain programmable power supply parameters corresponding to the power supply device.

It should be noted that, configuring the programmable power supply refers to configuring programmable power supply parameters corresponding to the power supply device based on the charging requirement information, so that the power supply device outputs the voltage and current required by the battery module based on programmable power supply parameters.

Programmable power supply parameters can include a power supply output voltage and a power supply output current corresponding to the power supply device 20. The power supply output voltage can be expressed as V_{PPS}, and its voltage range is V_{PPS_min}˜V_{PPS_max}. The power supply output current can be expressed as I_{PPS}, and its voltage range is 0˜I_{PPS} max. I_{PPS_max} refers to a maximum current output by the power supply device 20.

In the aforementioned embodiment, by configuring the programmable power supply for the power supply device based on the charging requirement information, programmable power supply parameters corresponding to the power supply device can be obtained. Subsequently, the power supply device can be controlled to output the charging voltage and charging current required by the battery module based on programmable power supply parameters.

In some embodiments, when the power supply device supports the programmable power supply, a maximum charging voltage of the battery module is half of a maximum power supply output voltage output by the power supply device, a minimum charging voltage of the battery module is half of a minimum power supply output voltage output by the power supply device.

It should be noted that, in an embodiment of this application, when the power supply device supports the programmable power supply, if the battery module has cells with a high-rate charging characteristic and the range of charging voltage of the battery module is V_{PPS_min}/2˜ V_{PPS_max}/2, the fastest charging speed can be achieved, maximum charging current of the battery module is I_{BAT_max}=2×I_{PPS} max. It should be understood that, since the charge pump unit can halve the voltage, charging with a high current (which is double maximum current output by the power supply device) can be achieved when the charging voltage of the battery module meets the condition of V_{PPS_min}/2˜V_{PPS_max}/2.

In some embodiments, according to the charging requirement information, configuring the programmable power supply for the power supply device to obtain programmable power supply parameters corresponding to the power supply device includes: based on a preset first voltage configuration formula, according to the charging requirement voltage, determining a power supply output voltage corresponding to the power supply device, the power supply output voltage is the sum of twice the charging requirement voltage and a preset voltage compensation value; based on a preset current configuration formula, according to the charging requirement current, determining a power supply output current corresponding to the power supply device, the power supply output current is the sum of half of the charging requirement current and a preset current compensation value; generating the programmable power supply parameters based on the power supply output voltage and the power supply output current.

For example, the preset first voltage configuration formula is as follows:

$${V}_{PPS} = 2 \times {V}_{BAT \_ chg} + Δ {V}_{fix}$$

In the above formula, ΔV_{fix} is the voltage compensation value, and V_{PPS} is the power supply output voltage. It should be noted that, the voltage compensation value ΔV_{fix} is set based on voltage losses caused by circuit design, passive components and different working temperatures. Different hardware designs, the use of different passive components, and different working temperatures can lead to different voltage losses in a circuit.

For example, by using the aforementioned first voltage configuration formula, according to the charging requirement voltage, the power supply output voltage corresponding to the power supply device can be determined. For example, if the charging requirement voltage V_{BAT_chg} is 5V, and the voltage compensation value ΔV_{fix} is 0.2V, the power supply output voltage V_{PPS} can be calculated as 10.2V.

For example, the preset first current configuration formula is as follows:

$${I}_{PPS} = {I}_{BAT \_ chg} / 2 + Δ {I}_{fix}$$

In the above formula, ΔI_{fix} is the current compensation value, I_{PPS} is the power supply output current. It should be noted that, the current compensation value ΔI_{fix} is set based on current losses caused by circuit design and passive components. Different hardware designs, the use of different passive components, and different working temperatures can lead to different current losses in a circuit.

For example, by using the aforementioned first current configuration formula, the power supply output current corresponding to the power supply device can be determined according to the charging requirement current. For example, if the charging requirement current I_{BAT_chg} IS 10A, and the current compensation value ΔI_{fix} is 0.5 A, the power supply output current I_{PPS} can be calculated as 5.5 A.

It should be noted that, given that the charge pump unit 104 halves the input voltage while doubling the input current during voltage conversion, to ensure that the power supply device outputs the voltage and current required by the battery module, the power supply output voltage of the power supply device needs to be doubled relative to the charging requirement voltage, and the power supply output current of the power supply device needs to be halved relative to the charging requirement current.

In the aforementioned embodiment, by configuring the power supply output voltage as the sum of twice the charging requirement voltage and the preset voltage compensation value, the voltage losses caused by circuit design, passive components and different working temperatures can be fully considered during the charging process, thereby improving the accuracy and precision of the power supply output voltage of the power supply device, and ensuring that the power supply device can output the voltage required by the battery module. By configuring the power supply output current as the sum of half of the charging requirement current and the preset current compensation value, the current losses caused by circuit design, passive components and different working temperatures can be fully considered during the charging process, thereby improving the accuracy and precision of the power supply output current of the power supply device, and ensuring that the power supply device can output the current required by the battery module.

For example, after determining the power supply output voltage and the power supply output current, generating the programmable power supply parameters according to the power supply output voltage and the power supply output current.

In step 2023, controlling the power supply device to supply power to the charge pump unit according to the programmable power supply parameters.

For example, after configuring the programmable power supply for the power supply device according to the charging requirement information to obtain programmable power supply parameters corresponding to the power supply device, the power controller can control the power supply device to supply power to the charge pump unit according to the programmable power supply parameters.

In some embodiments, controlling the power supply device to supply power to the charge pump unit according to the programmable power supply parameters, can include: transmitting a first programmable power supply request to the power supply device, the first programmable power supply request is configured to indicate the power supply device to supply power to the charge pump unit according to the power supply output voltage and the power supply output current; after detecting the output voltage from the power supply device, controlling the first switching circuit to be conducted, and enabling the power supply device to supply power to the charge pump unit.

For example, the first programmable power supply request can include a power supply output voltage and a power supply output current. The power supply device can output the voltage according to the power supply output voltage and output the current according to the power supply output current. The power controller can detect whether the power supply device is outputting the voltage by sampling the port charging and discharging path (the path between the charging and discharging interface and the first switching circuit is the port charging and discharging path). After detecting the voltage output by the power supply device, controlling the first switching circuit to be conducted, opening the port charging and discharging path, to make the power supply device supply power to the charge pump unit.

In the aforementioned embodiments, by transmitting the first programmable power supply request to the power supply device, the power supply device can be controlled to supply power to the charge pump unit according to the power supply output voltage and power supply output current. Since the charge pump has high conversion efficiency and low heat loss during fast charging, the battery module can be charged in an extremely short time, greatly enhancing the user experience. Additionally, it can also prevent the battery module from working in a high-temperature environment for a long time, thereby ensuring the charging efficiency and safety of the battery module.

In some embodiment, controlling the charge pump unit to charge the battery module, can include: controlling the charge pump controller to enter a charging mode, to make the charge pump controller control the first voltage conversion circuit to charge the battery module after entering the charging mode.

For example, the power controller can transmit a charging instruction to the charge pump controller, to make the charge pump controller enter the charging mode according to the charging instruction.

As shown in FIG. 3, the charge pump controller 1040, after entering the charging mode, can transmit a conduction signal to the second switching circuit 1042, to make the second switching circuit 1042 conduct the connection between the first switching circuit 108 and the first voltage conversion circuit 1041 when receiving the conduction signal from the charge pump controller 1040. The power controller 102 can also transmit a conduction signal to the third switching circuit 1043, to make the third switching circuit 1043 conduct the connection between the first voltage conversion circuit 1041 and the battery module 105 when receiving the conduction signal from the power controller 102.

It should be noted that, by conducting the connection between the first voltage conversion circuit 1041 and the battery module 105, it can open a charge pump charging path between the first voltage conversion circuit 1041 and the battery module 105.

In an embodiment of this application, during controlling the charge pump unit to charge the battery module, in order to improve the precision of the programmable power supply, the current charging voltage and current charging current of the battery module can be obtained in real time, dynamically adjusting the power supply output voltage of the power supply device according to the current charging voltage, and dynamically adjusting the power supply output current of the power supply device according to the current charging current. The following will provide a detailed description of the dynamic adjustment of the output of the power supply device.

Please refer to FIG. 8, FIG. 8 is a schematic flowchart of a sub-step for dynamically adjusting the output of a power supply device provided in an embodiment of this application. As shown in FIG. 8, it can include the following steps.

In step 2024, during controlling the charge pump unit to charge the battery module, obtaining a current charging voltage and a current charging current of the battery module, and obtaining a current port voltage and a current port current of the charging and discharging interface.

For example, during controlling the charge pump unit to charge the battery module, the power controller can collect the current charging voltage and current charging current of the battery module through a battery management system. The power controller can also collect a current port voltage V_{USB} and a current port current IUSB of the charging and discharging interface. It should be understood that, the current port voltage V_{USB} is equivalent to the power supply output voltage of the power supply device, the current port current IUSB is equivalent to the power supply output current of the power supply device.

In step 2025, according to the current charging voltage and the current port voltage, determining a voltage compensation variation value of the energy storage device, and according to the voltage compensation variation value, adjusting the power supply output voltage of the power supply device to obtain an adjusted power supply output voltage.

It should be noted that, during the charging process, since the working temperature of the device changes, the voltage losses and current losses also change. It is necessary to adjust the output of the power supply device according to the changed voltage losses and current losses, to ensure that the output of the power supply device meets the required voltage and current for the battery module.

For example, by using the aforementioned voltage configuration formula, according to the current charging voltage and the current port voltage, determining a voltage compensation variation value of the energy storage device. For example, if the current charging voltage is 4.8V, the current port voltage V_{USB} is 10.2V, and the preset voltage compensation value is 0.2V, a current voltage compensation value can be calculated as 0.6V. This indicates that the voltage loss of the energy storage device has increased during the charging process. According to the preset voltage compensation value 0.2V and the current voltage compensation value 0.6V, the voltage compensation variation value can be calculated as 0.4V, this means that the voltage loss has increased by 0.4V. At this point, in order to offset the increased voltage loss, the power supply output voltage of the power supply device 20 can be adjusted according to the voltage compensation variation value. For example, controlling the power supply output voltage to increase by 0.4V. If the original power supply output voltage V_{PPS} of the power supply device 20 is 10.2V, the power supply output voltage V_{PPS} can be adjusted to 10.6V. It should be understood that, the voltage compensation variation value is equivalent to the variation value of the voltage loss.

In the aforementioned embodiment, in order to reduce the impact of voltage loss variations during the charging process on the charging efficiency of the battery module, through determining a voltage compensation variation value of the energy storage device, and according to the voltage compensation variation value, adjusting the power supply output voltage of the power supply device, dynamically adjusting the power supply output voltage of the power supply device according to the voltage loss variation value can be achieved, thereby improving the accuracy and precision of the power supply output voltage of the power supply device, and ensuring that the power supply device can accurately output the voltage required by the battery module.

In step 2026, according to the current charging current and the current port current, determining a current compensation variation value of the energy storage device, and according to the current compensation variation value, adjusting the power supply output current of the power supply device to obtain an adjusted power supply output current.

For example, based on the aforementioned current configuration formula, determining a current compensation variation value of the energy storage device according to the current charging current and the current port current. For example, if the current charging current is 9.8V, the current port current IUSB is 5.5V, the preset current compensation value is 0.5 A, the current current compensation value can be calculated as 0.9 A. This indicates that the current loss of the energy storage device has increased during the charging process. According to the preset current compensation value 0.5 A and the current current compensation value 0.9 A, the current compensation variation value can be calculated as 0.4 A. This means that the current loss has increased by 0.4 A. At this point, in order to offset the increased current loss, the power supply output current of the power supply device can be adjusted according to the current compensation variation value. For example, controlling the power supply output current to increase by 0.4 A. If the original power supply output current I_{PPS} of the power supply device is 5.5 A, the power supply output current I_{PPS} can be adjusted to 5.9 A.

In the aforementioned embodiment, in order to reduce the impact of current loss variations during the charging process on the charging efficiency of the battery module, through determining a current compensation variation value of the energy storage device, and adjusting the power supply output current of the power supply device according to the current compensation variation value, dynamically adjusting the power supply output current of the power supply device according to the current loss variation value can be achieved, thereby improving the accuracy and precision of the power supply output current of the power supply device, and ensuring that the power supply device can accurately output the current required by the battery module.

In step 2027, transmitting a second programmable power supply request to the power supply device, the second programmable power supply request is configured to indicate the power supply device to supply power to the charge pump unit according to the adjusted power supply output voltage and/or the adjusted power supply output current.

For example, after obtaining an adjusted power supply output voltage and an adjusted power supply output current, it can generate a second programmable power supply request according to the adjusted power supply output voltage and the adjusted power supply output current, and transmit the second programmable power supply request to the power supply device to make the power supply device supply power to the charge pump unit according to the adjusted power supply output voltage and/or the adjusted power supply output current.

In the aforementioned embodiment, through transmitting the second programmable power supply request to the power supply device, that makes the power supply device supply power to the charge pump unit according to the adjusted power supply output voltage and/or the adjusted power supply output current, dynamically controlling the power supply device to supply power with the programmable power supply can be achieved, thereby improving the accuracy and precision of the power supply output current and the power supply output voltage of the power supply device, and ensuring that the power supply device can output the voltage and current required by the battery module.

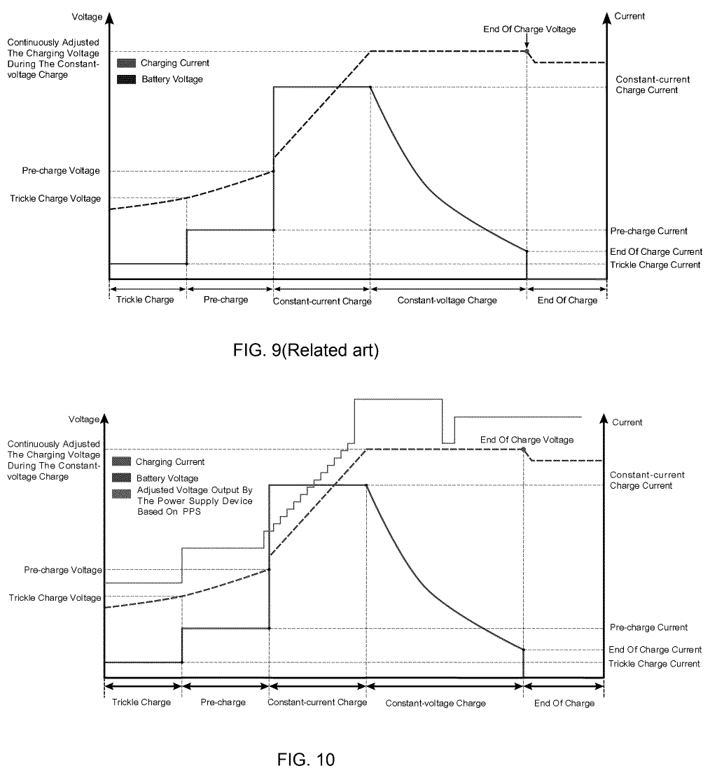

Please refer to FIG. 9, FIG. 9 is a charging curve diagram of a lithium battery in traditional technology. As shown in FIG. 9, the left vertical axis represents voltage, the right vertical axis represents current, the red curve represents the charging current of a lithium battery, and the blue curve represents the battery voltage of the lithium battery. The charging process of the lithium battery mainly includes processes such as trickle charge, pre-charge, constant-current charge, constant-voltage charge and end of charge.

As can be seen from the charging curve in FIG. 9, it is necessary to continuously adjust the charging voltage and charging current during the charging process. The programmable power supply characteristic of the power supply device supports the dynamic adjustment of the charging voltage and charging current. The embodiment of this application can control the power supply device to perform the programmable power supply based on the programmable power supply characteristic of the power supply device.

Please refer to FIG. 10, FIG. 10 is a charging curve diagram of a battery module supplied power with a programmable power supply based on the fast charging protocol of the USB Type-C interface provided in an embodiment of this application. As shown in FIG. 10, the left vertical axis represents voltage, the right vertical axis represents current, the green curve represents an adjusted voltage output by the power supply device based on the programmable power supply, the red curve represents the charging current of a lithium battery, and the blue curve represents the battery voltage of the lithium battery. For example, it can dynamically adjust the voltage of these processes of trickle charge, pre-charge, constant-current charge, constant-voltage charge and end of charge.

It should be noted that, in the case of using the USB PD3.0 fast charging protocol, the output voltage rang of the power supply device is 3.3V-21V. The voltage regulation accuracy reaches 20 mV. Maximum output current of the power supply device is 5 A. The current regulation accuracy reaches 50 mA. This fully meets the accuracy requirements for the charging voltage and charging current at different charging stages of the lithium battery.

In step 203, if the power supply device supports multiple power data objects to supply power, disconnecting the connection between the charge pump unit and the battery module, controlling the power supply device to supply power to the DC-to-DC conversion unit based on a power supply mode with a fixed power data object, and controlling the DC-to-DC conversion unit to charge the battery module.

For example, as shown in FIG. 3, when the power supply device 20 supports multiple power data objects to supply power, the power controller 102 can disconnect the connection between the charge pump unit 104 and the battery module 105. For example, the power controller 102 can transmit a shutdown signal to the third switching circuit 1043, and control the third switching circuit 1043 to be turned off, which makes the third switching circuit 1043 disconnect the connection between the charge pump unit 104 and the battery module 105.

For example, after disconnecting the connection between the charge pump unit 104 and the battery module 105, the power controller 102 can control the power supply device 20 to supply power to the DC-to-DC conversion unit 103 based on a power supply mode with a fixed power data object. Wherein the power supply mode with a fixed power data object refers to powering the DC-to-DC conversion unit 103 at an output voltage corresponding to one of multiple power data objects.

In the aforementioned embodiments, when the power supply device supports multiple power data objects to supply power, controlling the power supply device to supply power to the DC-to-DC conversion unit based on a power supply mode with a fixed power data object can achieve that the DC-to-DC conversion unit is used to charge the battery module when the power supply device does not support the programmable power supply, thereby improving the compatibility of the energy storage device.

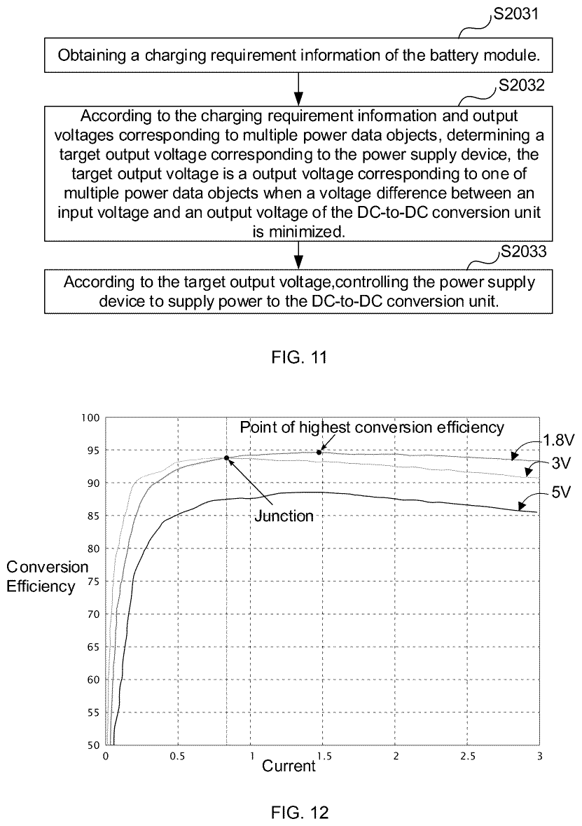

Please refer to FIG. 11, FIG. 11 is a schematic flowchart of a sub-step for controlling the power supply device to supply power to a DC-to-DC conversion unit provided in an embodiment of this application. As shown in FIG. 11, in step 203, controlling the power supply device to supply power to the DC-to-DC conversion unit based on a power supply mode with a fixed power data object, can include the following steps.

In step 2031, obtaining a charging requirement information of the battery module.

For example, as shown in FIG. 3, the power controller 102 can obtain the charging requirement information of the battery module 105, wherein the charging requirement information is collected by the battery management system 107. Wherein the charging requirement information includes a charging requirement voltage and a charging requirement current.

In step 2032, according to the charging requirement information and output voltages corresponding to multiple power data objects, determining a target output voltage corresponding to the power supply device, the target output voltage is an output voltage corresponding to one of multiple power data objects when a voltage difference between an input voltage and an output voltage of the DC-to-DC conversion unit is minimized.

For example, after obtaining the charging requirement information of the battery module 105, determining the target output voltage corresponding to the power supply device 20 according to the charging requirement information and output voltages corresponding to multiple power data objects. Wherein the target output voltage is an output voltage of the power supply device 20 when a voltage difference between an input voltage and an output voltage of the DC-to-DC conversion unit 103 is minimized.

It should be noted that, for the DC-to-DC conversion unit 103, when the input current is constant, the greater the voltage difference between the input voltage and the output voltage (load), the lower the conversion efficiency of the DC-to-DC conversion unit 103. Conversely, the smaller the voltage difference between the input voltage and the output voltage, the higher the conversion efficiency of the DC-to-DC conversion unit 103.

Please refer to FIG. 12, FIG. 12 is a relationship curve diagram between the conversion efficiency and different voltage differences in a DC-to-DC conversion unit provided in an embodiment of this application. As shown in FIG. 12, the horizontal axis represents the current of the DC-to-DC conversion unit 103, the unit is Ampere (A), the vertical axis represents the conversion efficiency of the DC-to-DC conversion unit 103, and the three curves represent three voltage differences of 5V, 3V, and 1.8V, respectively. The point of highest conversion efficiency refers that the conversion efficiency of the DC-to-DC conversion unit 103 is the highest when the current is greater than a certain value. For example, the conversion efficiency of the DC-to-DC conversion unit 103 is the highest when the voltage difference is 1.8V. The junction refers that when the current is less than a certain value, the conversion efficiency of the DC-to-DC conversion unit 103 corresponding to the greater voltage difference is higher, and when the current is greater than the certain value, the conversion efficiency of the DC-to-DC conversion unit 103 corresponding to the greater voltage difference is lower.

In some embodiments, according to the charging requirement information and output voltages corresponding to multiple power data objects, determining a target output voltage, which can include: obtaining a minimum voltage difference corresponding to the charging requirement current and a preset voltage compensation value; configuring the charging requirement voltage, minimum voltage difference and the voltage compensation value to obtain a target output voltage based on a preset minimum voltage difference formula and output voltages corresponding to multiple power data objects.

For example, when determining the target output voltage, it is necessary to obtain minimum voltage difference corresponding to the charging requirement current. It should be noted that, different charging requirement currents correspond to different minimum voltage differences. For example, as shown in FIG. 12, when the current is less than 0.8 A, the conversion efficiency corresponding to minimum voltage difference 3V is the highest; when the current is greater than 0.8 A, the conversion efficiency corresponding to minimum voltage difference 1.8V is the highest.

For example, when determining the target output voltage, it is necessary to obtain a preset voltage compensation value. Wherein the voltage compensation value can be expressed as ΔV_{fix}. The voltage compensation value ΔV_{fix} can be set based on the actual situation, and the specific value is not limited here. It should be noted that, the voltage compensation value ΔV_{fix} is set based on voltage losses caused by circuit design and passive components. It should be understood that, different hardware designs, the use of different passive components, and different working temperatures can lead to different voltage losses in a system. Therefore, in order to precisely control the DC-to-DC conversion unit to work at the highest conversion efficiency, it is necessary to add the voltage compensation value ΔV_{fix} when determining the target output voltage.

For example, after obtaining a minimum voltage difference corresponding to the charging requirement current and a preset voltage compensation value, configuring the charging requirement voltage, minimum voltage difference and the voltage compensation value to obtain a target output voltage based on a preset minimum voltage difference formula and output voltages corresponding to multiple power data objects.

For example, minimum voltage difference formula is as following:

$$\vert {V}_{PSU} - {V}_{BAT \_ chg} \vert = Δ {V}_{{io}_{eff}} + Δ {V}_{fix}$$

In the above formula, ΔVᵢₒ_{_{eff}} represents minimum voltage difference corresponding to the highest conversion efficiency of the DC-to-DC conversion unit 103 when the charging requirement current is I_{BAT_chg}. Different DC-to-DC conversion units 103 probably correspond to different minimum voltage differences ΔVᵢₒ_{_{eff}}; V_{PSU} is one of output voltages corresponding to multiple power data objects of the power supply device 20, output voltages are such as V_{PDO-1}, V_{PDO-2}, V_{PDO-3}, . . . , V_{PDO-n}.

For example, the charging requirement voltage V_{BAT_chg}, minimum voltage difference ΔVᵢₒ_{_{eff}} and the voltage compensation value ΔV_{fix} are substituted into minimum voltage difference formula to obtain a configured output voltage V_{PSU}, and the configured output voltage V_{PSU} is determined as the target output voltage.

In step 2033, according to the target output voltage, controlling the power supply device to supply power to the DC-to-DC conversion unit.

For example, after determining the target output voltage corresponding to the power supply device 20, the power controller 102 can control the power supply device 20 to supply power to the DC-to-DC conversion unit 103 according to the target output voltage.

For example, controlling the power supply device 20 to supply power to the DC-to-DC conversion unit 103 according to the target output voltage can include: transmitting a standard fast charging request to the power supply device 20, the standard fast charging request is configured to indicate the power supply device 20 supplies power to the DC-to-DC conversion unit 103 according to the target output voltage and the output current corresponding to the target output voltage. Wherein the output current corresponding to the target output voltage can be determined according to the output power of the power supply device 20.

In the aforementioned embodiments, through configuring the charging requirement voltage, minimum voltage difference and the voltage compensation value to obtain a target output voltage based on a minimum voltage difference formula and output voltages corresponding to multiple power data objects, and controlling the power supply device to charge the battery module according to the target output voltage, at this point, the voltage difference between the input voltage and the output voltage of the DC-to-DC conversion unit is minimum, thereby the DC-to-DC conversion unit can charge the battery module at the highest conversion efficiency. That improves the charging efficiency of the battery module. Additionally, controlling the DC-to-DC conversion unit to charge the battery module at the highest conversion efficiency can also reduce the losses and heat generation of the entire system during the charging state.

In some embodiments, controlling the DC-to-DC conversion unit to charge the battery module can include: transmitting a fourth conduction signal to the fourth switching circuit to enable the fourth switching circuit to conduct the connection between the second voltage conversion circuit and the battery module after receiving the fourth conduction signal; according to the charging requirement information, configuring charging output parameters of the DC-to-DC converter, and setting a working mode of the DC-to-DC converter 1030 to a charging mode, to enable the DC-to-DC converter to control the second voltage conversion circuit to charge the battery module based on configured charging output parameters.

For example, as shown in FIG. 3, the power controller 102 can transmit a fourth conduction signal to the fourth switching circuit 1032, to control the fourth switching circuit 1032 to conduct the connection between the second voltage conversion circuit 1031 and the battery module 105.

In an embodiment of this application, before controlling the DC-to-DC conversion unit to charge the battery module, it is necessary to configure working parameters and modes of the DC-to-DC conversion unit.

For example, parameters of the DC-to-DC conversion unit are configured based on the charging requirement information. Wherein working parameters of the DC-to-DC conversion unit mainly include a charging voltage V_{DCDC_Chg} and a charging current I_{DCDC_Chg}. The charging voltage V_{DCDC_Chg} can be calculated by using a preset second voltage configuration formula, and the charging current I_{DCDC_Chg} can be calculated by using a preset second current configuration formula.

Wherein the second voltage configuration formula is as following:

$${V}_{DCDC \_ Chg} = {V}_{BAT \_ chg} + Δ {V}_{fix} .$$

In the above formula, ΔV_{fix} is the voltage compensation value. For example, when the charging requirement voltage V_{BAT_chg} is 5V, the voltage compensation value ΔV_{fix} is 0.2V, the charging voltage V_{DCDC_Chg} can be calculated as 5.2V.

The second current configuration formula is as following:

$${I}_{DCDC \_ Chg} = {I}_{BAT \_ chg} + Δ {I}_{fix} .$$

In the above formula, ΔI_{fix} is the current compensation value. For example, when the charging requirement current I_{BAT_chg} is 10 A, and the current compensation value ΔI_{fix} is 0.5 A, the charging current I_{DCDC_Chg} can be calculated as 10.5 A.

For example, the power controller can communicate with the DC-to-DC conversion unit. The work mode of the DC-to-DC conversion unit is set as a charging mode. It should be noted that, the work mode of the DC-to-DC conversion unit can include a discharging mode and a charging mode. When it needs to charge the battery module, the work mode of the DC-to-DC conversion unit needs to be set as the charging mode.

In the aforementioned embodiments, through configuring charging output parameters of the DC-to-DC converter according to the charging requirement information of the battery module, it can enable the DC-to-DC converter to output the voltage and current required by the battery module based on configured charging output parameters. At the same time, it can enable the voltage difference between the input voltage and the output voltage of the DC-to-DC conversion unit to be minimum, thereby the DC-to-DC conversion unit can charge the battery module at the highest conversion efficiency. That improves the charging efficiency of the battery module.

In an embodiment of this application, combining the aforementioned FIGS. 1 to 3, when the power supply device supports the programmable power supply, charging the battery module based on a power supply mode with the programmable power supply mainly includes the following steps.
(1) The power controller 102 checks the DC-to-DC converter 1030 to confirm that the DC-to-DC converter 1030 is in an off state, and closes the fourth switching circuit 1032 to disconnect the charging and discharging path between the DC-to-DC conversion unit 103 and the battery module 105.
(2) The power controller 102 requests the battery management system 107 to obtain the actual state of the battery module 105 through the micro-controller 106.
(3) When the power controller 102, based on the real-time SoC feedback collected by the battery management system 107 for the battery module 105, confirms the battery module 105 in a normal state (when the fifth switching circuit 110 is open), the charging voltage V_{BAT_chg} and the charging current I_{BAT_chg} are determined in combining with the characteristics of the battery being used, and parameters of the battery management system 107, such as charging parameters and protection parameters, are set through the micro-controller 106. If not, it exits the workflow and reports the error to the micro-controller 106, which then informs the user of the exception through the interactive module 109.
(4) The power controller 102 transmits a PPS request to the power supply device 20 based on the fast charging protocol of PPS, to obtain the power supply output voltage V_{PPS} (V_{PPS}=2×V_{BAT_chg}+ΔV_{fix}) and the power supply output current I_{PPS} (I_{PPS}=I_{BAT_chg}/2+ΔI_{fix}).
(5) The power controller 102, after detecting that the power supply device 20 is outputting the voltage by sampling the port charging and discharging path (the path between the charging and discharging interface 101 and the first switching circuit 108), opens the first switching circuit 108.
(6) The power controller 102 opens the third switching circuit 1043, to open the charge pump charging path.
(7) The power controller 102 communicates with the charge pump controller 1040 to notify it to enter the working state.
(8) The charge pump controller 1040, after receiving the notification, opens the second switching circuit 1042 to control the first voltage conversion circuit 1041 to enter the working state and to charge the battery module 105.
(9) The power controller 102 maintains communication with the charge pump controller 1040 to confirm that the charge pump controller 1040 has entered the working state, and to report to the micro-controller 106.
(10) The micro-controller 106, after receiving the notification, communicates with the battery management system 107 to obtain the real-time state of the battery module 105, and to feedback to the power controller 102.
(11) The power controller 102 can obtain the information of the battery module 105 collected by the battery management system 107 in real time through the micro-controller 106, and relevant parameters of the power charging and discharging path (such as temperatures, voltages, SoC (State of Charge) state information, and the voltage V_{BAT_chg} and the current I_{BAT_chg} of the actual charging circuit, etc.).
(12) The power controller 102, based on the SoC feedback collected by the battery management system 107 for the battery module 105 or using other SoC algorithms, adjusts ΔV_{fix} and ΔI_{fix} by combing the power supply end information (the voltage V_{USB} and current IUSB of the port charging and discharging path) known by oneself, and sends the PPS request to the power supply device 20 to apply a new V_{PPS} and a new I_{PPS}.
(13) The power controller 102 reports the adjustment information to the micro-controller 106. The micro-controller 106 informs the user through the interactive module 109.
(14) If in step 10, the power controller 102, through the feedback information from the micro-controller 106, learns that the battery module 105 has not yet been fully charged, and the charge pump controller 1040 has not reported any exceptions to the power controller 102, then it will continuously repeat steps (9) to (13). Otherwise (if the battery module 105 has been fully charged), it proceeds to the following steps.
(15) If the battery module 105 has been fully charged, the power controller 102 immediately notifies the charge pump controller 1040 to stop working.
(16) The charge pump controller 1040, after receiving the notification, stops controlling the first voltage conversion circuit 1041, closes the output, and controls the second switching circuit 1042 to cut off the input circuit.
(17) The power controller 102, after confirming that the charge pump controller 1040 stops working, controls the third switching circuit 1043 to cut off the charging output path of the charge pump.
(18) The power controller 102 requests the power supply device 20 to output a safe voltage, for example, 5V.
(19) The power controller 102 controls the first switching circuit 108 to cut off the input circuit of the power supply device 20.
(20) The power controller 102 sends a notification to the micro-controller 106, informing that the system has completed charging and is ready to enter standby mode.
(21) After completing all possible operations (such as user interaction, system state checks, etc.), the micro-controller 106 delays for a certain period before notifying the connected power controller 102, battery management system 107, and interactive module 109 to enter a low-power sleep state, and then it also enters a low-power sleep state itself.

In an embodiment of this application, combining the aforementioned FIGS. 1 to 3, when the power supply device supports multiple power data objects to supply power, charging the battery module based on a power supply mode with a fixed power data object mainly includes the following steps.
(1) The power controller 102 checks the charge pump controller 1040 to confirm that the charge pump controller 1040 is in an off state, and closes the third switching circuit 1043 to disconnect the charging path between the charge pump unit 104 and the battery module 105.
(2) The power controller 102 requests the battery management system 107 to obtain the actual state of the battery through the micro-controller 106.
(3) When the power controller 102, based on the real-time SoC feedback collected by the battery management system 107 for the battery module 105, confirms the battery module 105 in a normal state (when the fifth switching circuit 110 is open), the charging voltage and the charging current are determined in combining with the characteristics of the battery being used, and parameters of the battery management system 107, such as charging parameters and protection parameters, are set through the micro-controller 106. If not, it exits the workflow and reports the error to the micro-controller 106, which then informs the user of the exception through the interactive module 109.
(4) The power controller 102 transmits a PD request to the external PSU based on the fast charging protocol of PD to obtain the fixed fast charging power data object corresponding to the highest conversion efficiency, which includes a target output voltage (a voltage corresponding to one of multiple power data objects) and a current (which is determined according to the output power of the power supply device 20, different power data objects may correspond to different maximum output currents.).
(5) The power controller 102, after detecting that the power supply device 20 is outputting the voltage by sampling the port charging and discharging path (the path between the charging and discharging interface 101 and the first switching circuit 108), opens the first switching circuit 108.
(6) The power controller 102 opens the fourth switching circuit 1032, to open the charging and discharging path between the second voltage conversion circuit 1031 and the battery module 105.
(7) The power controller 102 communicates with the DC-to-DC converter 1030 to set charging output parameters of the DC-to-DC converter 1030, such as the charging voltage and the charging current, and notify it to enter the working state.
(8) The DC-to-DC converter 1030, after receiving the notification, controls the second voltage conversion circuit 1031 to enter the charging working state and start charging the battery module 105.
(9) The power controller 102 maintains communication with the DC-to-DC converter 1030 to confirm that the DC-to-DC converter 1030 has entered the working state, and to report to the micro-controller 106.
(10) The micro-controller 106, after receiving the notification, communicates with the battery management system 107 to obtain the real-time state of the battery module 105, and to feedback to the power controller 102.
(11) The power controller 102 can obtain the information of the battery module 105 collected by the battery management system 107 in real time through the micro-controller 106, and relevant parameters of the power charging and discharging path (such as temperatures, voltages, SoC state information, and the voltage and the current of the actual charging circuit, etc.).
(12) The power controller 102, based on the SoC feedback collected by the battery management system 107 for the battery module 105 or using other SoC algorithms, corrects the voltage compensation value ΔV_{fix} and the current compensation value ΔI_{fix} by combing the power supply end information (the voltage and current of the port charging and discharging path) known by oneself and the information of DC-to-DC charging path (the actual charging output voltage and output current of DC-DC), and sends an adjustment request for the output to the DC-to-DC converter 1030.
(13) The power controller 102 reports the adjustment information to the micro-controller 106. The micro-controller 106 informs the user through the interactive module 109.
(14) If in step 10, the power controller 102, through the feedback information from the micro-controller 106, learns that the battery module 105 has not yet been fully charged, and the second voltage conversion circuit 1031 has not reported any exceptions to the power controller 102, then it will continuously repeat steps (9) to (12). Otherwise (if the battery module 105 has been fully charged), it proceeds to the following steps.
(15) If the battery module 105 has been fully charged, the power controller 102 immediately notifies the DC-to-DC converter 1030 to stop working.
(16) The DC-to-DC converter 1030, after receiving the notification, stops controlling the second voltage conversion circuit 1031, and closes the output.
(17) The power controller 102, after confirming that the DC-to-DC converter 1030 stops working, controls the fourth switching circuit 1032 to cut off the charging output path of the second voltage conversion circuit 1031.
(18) The power controller 102 requests the power supply device 20 to output a safe voltage (5V).
(19) The power controller 102 controls the first switching circuit 108 to cut off the input circuit of the power supply device 20.
(20) The power controller 102 sends a notification to the micro-controller 106, informing that the system has completed charging and is ready to enter standby mode.
(21) After completing all possible operations (such as user interaction, system state checks, etc.), the micro-controller 106 delays for a certain period before notifying the connected power controller 102, battery management system 107, and interactive module 109 to enter a low-power sleep state, and then it also enters a low-power sleep state itself.

An embodiment of this application further provides a computer-readable storage medium, the computer-readable storage medium stores a computer program. The computer programs includes program instructions. The processor executes these program instructions to perform any one of charging control methods provided by the embodiments of this application. For example, the computer program is invoked by the processor to perform the following steps.

When detecting that the power supply device is connected to the charging and discharging interface, obtaining a power supply capability information of the power supply device, the power supply capability information includes that the power supply device can support multiple power data objects to supply power or support a programmable power supply; if the power supply device supports the programmable power supply, disconnecting the connection between the DC-to-DC conversion unit and the battery module, controlling the power supply device to supply power to the charge pump unit with the programmable power supply, and controlling the charge pump unit to charge the battery module; if the power supply device supports multiple power data objects to supply power, disconnecting the connection between the charge pump unit and the battery module, controlling the power supply device to supply power to the DC-to-DC conversion unit based on a power supply mode with a fixed power data object, and controlling the DC-to-DC conversion unit to charge the battery module.

The specific implementation of the above operations can be seen in the aforementioned embodiments, and will not be repeated here.

A computer-readable storage medium can be an internal storage unit of the aforementioned energy storage device, such as the hard disk drive or memory of the energy storage device. The computer-readable storage medium can also be an external storage device of the energy storage device, such as a pluggable hard disk drive, a smart media card (SMC), a secure digital (SD) card, a flash card equipped on the energy storage device.

The aforementioned descriptions are merely specific embodiments of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A charging control method, applied to an energy storage device, wherein the energy storage device comprising a charging and discharging interface, a DC-to-DC conversion unit, a charge pump unit and a battery module, the DC-to-DC conversion unit is connected between the charging and discharging interface and the battery module, the charge pump unit is connected between the charging and discharging interface and the battery module, the method comprises:
when detecting that a power supply device is connected to the charging and discharging interface, obtaining a power supply capability information of the power supply device, wherein the power supply capability information comprises that the power supply device can support multiple power data objects to supply power or support a programmable power supply;
if the power supply device supports the programmable power supply, disconnecting the connection between the DC-to-DC conversion unit and the battery module, controlling the power supply device to supply power to the charge pump unit with the programmable power supply, and controlling the charge pump unit to charge the battery module; or
if the power supply device supports multiple power data objects to supply power, disconnecting the connection between the charge pump unit and the battery module, controlling the power supply device to supply power to the DC-to-DC conversion unit based on a power supply mode with a fixed power data object, and controlling the DC-to-DC conversion unit to charge the battery module.

2. The method according to claim 1, wherein the controlling the power supply device to supply power to the charge pump unit with the programmable power supply comprises:
obtaining a charging requirement information of the battery module;
configuring the programmable power supply according to the charging requirement information for the power supply device to obtain programmable power supply parameters corresponding to the power supply device; and
controlling the power supply device to supply power to the charge pump unit according to the programmable power supply parameters.

3. The method according to claim 2, wherein the charging requirement information comprises a charging requirement voltage and a charging requirement current;
the configuring the programmable power supply according to the charging requirement information for the power supply device to obtain programmable power supply parameters corresponding to the power supply device comprises:
determining a power supply output voltage corresponding to the power supply device according to the charging requirement voltage, wherein the power supply output voltage is the sum of twice the charging requirement voltage and a preset voltage compensation value;
determining a power supply output current corresponding to the power supply device according to the charging requirement current, wherein the power supply output current is the sum of half of the charging requirement current and a preset current compensation value; and
generating the programmable power supply parameters according to the power supply output voltage and the power supply output current.

4. The method according to claim 2, wherein the energy storage device further comprises a first switching circuit, the first switching circuit is connected to the charging and discharging interface and the charge pump unit; the programmable power supply parameters comprise a power supply output voltage and a power supply output current;
wherein the controlling the power supply device to supply power to the charge pump unit according to the programmable power supply parameters comprises:
transmitting a first programmable power supply request to the power supply device, wherein the first programmable power supply request is configured to indicate the power supply device to supply power to the charge pump unit according to the power supply output voltage and the power supply output current; and
after detecting an output voltage from the power supply device, controlling the first switching circuit to be conducted, and enabling the power supply device to supply power to the charge pump unit.

5. The method according to claim 1, wherein the charge pump unit comprises a charge pump controller and a first voltage conversion circuit, the charge pump controller is connected to the first voltage conversion circuit, one end of the first voltage conversion circuit is connected to the charging and discharging interface, and other end of the first voltage conversion circuit is connected to the battery module;
wherein the controlling the charge pump unit to charge the battery module comprises:
controlling the charge pump controller to enter a charging mode, to make the charge pump controller control the first voltage conversion circuit to charge the battery module after entering the charging mode.

6. The method according to claim 5, wherein the energy storage device further comprises a power controller and a first switching circuit, the charge pump unit further comprises a second switching circuit and a third switching circuit;
one end of the first switching circuit is connected to the charging and discharging interface, the other end of the first switching circuit is connected to a first end of the second switching circuit, a second end of the second switching circuit is connected to the first voltage conversion circuit, a third end of the second switching circuit is connected to the charge pump controller, a first end of the third switching circuit is connected to the first voltage conversion circuit, a second end of the third switching circuit is connected to the battery module, and a third end of the third switching circuit is connected to the power controller;
the first switching circuit is configured to conduct the connection between the charging and discharging interface and a second switching circuit when receiving a first conduction signal of the power controller;
the second switching circuit is configured to conduct the connection between the first switching circuit and the first voltage conversion circuit when receiving a second conduction signal of the charge pump controller; and
the third switching circuit is configured to conduct the connection between the first voltage conversion circuit and the battery module when receiving a third conduction signal from the power controller.

7. The method according to claim 5, wherein an output voltage of the first voltage conversion circuit is half of an input voltage during a charging phase, and an output current of the first voltage conversion circuit is twice an input current during a discharging phase.

8. The method according to claim 7, wherein the first voltage conversion circuit comprises a first energy storage capacitor, a second energy storage capacitor, a first switching transistor, a second switching transistor, a third switching transistor and a fourth switching transistor;
a first end of the first switching transistor is connected to a power source end, a second end of the first switching transistor is connected to a first end of the second switching transistor, a second end of the second switching transistor is connected to a first end of the third switching transistor, a second end of the third switching transistor is connected to a first end of the fourth switching transistor, the fourth switching transistor is grounded;
a first end of the first energy storage capacitor is connected to a common node between the second end of the first switching transistor and the first end of the second switching transistor, a second end of the first energy storage capacitor is connected to a common node between the second end of the third switching transistor and the first end of the fourth switching transistor; a first end of the second energy storage capacitor is connected to a common node between the second end of the second switching transistor and the first end of the third switching transistor, a second end of the second energy storage capacitor is connected to a second end of the fourth switching transistor;
during the charging phase, the first switching transistor and the third switching transistor are configured to be conducted, the second switching transistor and the fourth switching transistor are configured to be off, and the first energy storage capacitor is connected in series with the second energy storage capacitor; and
during the discharging phase, the first switching transistor and the third switching transistor are configured to be off, the second switching transistor and the fourth switching transistor are configured to be conducted, and the first energy storage capacitor is connected in parallel with the second energy storage capacitor.

9. The method according to claim 1, wherein the method further comprises:
during controlling the charge pump unit to charge the battery module, obtaining a current charging voltage and a current charging current of the battery module, and obtaining a current port voltage and a current port current of the charging and discharging interface;
determining a voltage compensation variation value of the energy storage device according to the current charging voltage and the current port voltage, and adjusting a power supply output voltage of the power supply device to obtain an adjusted power supply output voltage according to the voltage compensation variation value;
determining a current compensation variation value of the energy storage device according to the current charging current and the current port current, and adjusting a power supply output current of the power supply device to obtain an adjusted power supply output current according to the current compensation variation value; and
transmitting a second programmable power supply request to the power supply device, wherein the second programmable power supply request is configured to indicate the power supply device to supply power to the charge pump unit according to the adjusted power supply output voltage and/or the adjusted power supply output current.

10. The method according to claim 1, wherein the controlling the power supply device to supply power to the DC-to-DC conversion unit based on a power supply mode with a fixed power data object comprises:
obtaining a charging requirement information of the battery module;
determining a target output voltage corresponding to the power supply device according to the charging requirement information and output voltages corresponding to multiple power data objects, wherein the target output voltage is an output voltage corresponding to one of multiple power data objects when a voltage difference between an input voltage and an output voltage of the DC-to-DC conversion unit is minimized; and
controlling the power supply device to supply power to the DC-to-DC conversion unit according to the target output voltage.

11. The method according to claim 10, wherein the charging requirement information comprises a charging requirement voltage and a charging requirement current;
the determining a target output voltage corresponding to the power supply device according to the charging requirement information and output voltages corresponding to multiple power data objects comprises:
obtaining a minimum voltage difference corresponding to the charging requirement current and a preset voltage compensation value; and
configuring the charging requirement voltage, minimum voltage difference and the voltage compensation value to obtain a target output voltage based on a preset minimum voltage difference formula and output voltages corresponding to multiple power data objects.

12. The method according to claim 10, wherein the energy storage device further comprises a power controller and a first switching circuit, the DC-to-DC conversion unit comprises a DC-to-DC converter, a second voltage conversion circuit and a fourth switching circuit, a first end of the second voltage conversion circuit is connected to the first switching circuit, a second end of the second voltage conversion circuit is connected to a first end of the fourth switching circuit, a second end of the fourth switching circuit is connected to the battery module, a third end of the fourth switching circuit is connected to the power controller; the DC-to-DC converter is connected to a third end of the second voltage conversion circuit;
wherein the controlling the DC-to-DC conversion unit to charge the battery module comprises:
transmitting a fourth conduction signal to the fourth switching circuit to enable the fourth switching circuit to conduct the connection between the second voltage conversion circuit and the battery module after receiving the fourth conduction signal; and
configuring charging output parameters of the DC-to-DC converter and setting a working mode of the DC-to-DC converter to a charging mode according to the charging requirement information, to enable the DC-to-DC converter to control the second voltage conversion circuit to charge the battery module based on configured charging output parameters.

13. The method according to claim 1, wherein a maximum charging voltage of the battery module is half of a maximum power supply output voltage output by the power supply device and a minimum charging voltage of the battery module is half of a minimum power supply output voltage output by the power supply device, when the power supply device supports the programmable power supply.

14. (canceled)

15. (canceled)

16. The method according to claim 1, wherein the obtaining a power supply capability information of the power supply device comprises:
communicating with the power supply device through the charging and discharging interface and transmitting a power supply capability request message to the power supply device; and
receiving a power supply capability information provided by the power supply device in response to the power supply capability request message.

17. The method according to claim 12, wherein the disconnecting the connection between the DC-to-DC conversion unit and the battery module comprises:
transmitting a shutdown signal to the fourth switching circuit;
controlling the fourth switching circuit, according to the shutdown signal, to be turned off, to make the fourth switching circuit disconnect the connection between the DC-to-DC conversion unit and the battery module.

18. The method according to claim 5, wherein the controlling the charge pump controller to enter a charging mode comprises:
transmitting a charging instruction to the charge pump controller, to make the charge pump controller enter a charging mode according to the charging instruction.

19. The method according to claim 10, wherein the energy storage device further comprises a battery management system;
wherein the obtaining a charging requirement information of the battery module comprises:
obtaining a charging requirement information of the battery module, wherein the charging requirement information is collected by the battery management system.

20. The method according to claim 6, wherein the DC-to-DC conversion unit and the power controller can be configured to integrate into a system-on-a-chip.

21. An energy storage device, wherein the energy storage device comprises a memory and a processor; the memory is configured to store a computer program; the processor is configured to execute the computer program and implement the charging control method according to claim 1.

22. A computer-readable storage medium, wherein the computer-readable storage medium stores a computer program, when the computer program is executed by a processor, the processor implements the charging control method according to claim 1.
